(19) United States
(12) Patent Application Publication
(10) Pub. No.: US 2009/0142503 A1
(43) Pub. Date: Jun. 4, 2009

(54) LUBRICATING A RUN-FLAT TIRE SYSTEM

(76) Inventors: Elizabeth L. Hotaling, Piedmont, SC (US); Laure M. Simonot, Chanalieis (FR); Philippe Esnault, Clermont-FD (FR)

Correspondence Address: MICHELIN NORTH AMERICA, INC.;INTELLECTUAL PROPERTY DEPARTMENT, MARC BLDG 31-2, 515 MICHELIN ROAD, GREENVILLE, SC, 29605, US

(21) Appl. No.: 11/948,559

(22) Filed: Nov. 30, 2007

(51) Int. Cl. C10M 107/24; B05D 1/02

(52) U.S. Cl. 427/422; 508/583

(57) ABSTRACT

A method and system of lubricating an interface between an interior surface of a tire and an outer surface of a safety support in a run-flat tire system. The method comprising applying a gel composition at the interface, wherein the gel composition comprises a base oil and a polyvinyl alcohol, the polyvinyl alcohol having a viscosity of between 25 and 75 centipoise at 20° C. in a 4% aqueous solution.

### BACKGROUND OF THE INVENTION

1. Field of the Invention

This invention relates generally to lubricants, and more specifically to methods and systems of lubricating the interior of run-flat tires.

2. Description of the Related Art

Run-flat tire systems have been developed to provide tires for vehicles that can be operated in a deflated condition for a suitable distance at a desired speed. Such systems have provided significant benefits to vehicle operators including safety benefits that are realized when, for example, a vehicle can continue traveling with a deflated tire under conditions that are not safe for changing the tire at the side of a road. Thus, run-flat tire systems improve the safety of the vehicle by allowing the vehicle to continue to travel for a certain time until a suitable place for repairs can be found.

Run-flat systems having safety support rings are well known. U.S. Pat. No. 6,944,948 of Pompier, which has been assigned to Michelin Recherche et Technique, discloses such a system. Pompier discloses a run-flat tire system having a safety support ring consisting of a circular body adapted for fitting onto a wheel rim of a vehicle. The disclosed safety support ring is comprised of a vulcanized rubber mix and includes areas that are reinforced by, for example, metallic or textile wires or cables. While Pompier discloses a safety support ring made of a vulcanized rubber mix, the support rings are not so limited and may be made, for example, of plastics such as polyurethane.

As Pompier discloses, safety support rings are generally mounted on a wheel rim inside a tire to provide support for the crown of the tire when it is rolling at low or zero pressure. The safety support ring is meant to prevent direct contact between the tire and the wheel rim because such contact generally results in rapid deterioration of the tire.

To improve rolling under the condition of low or zero pressure, it is preferable to provide lubrication at the interface between the inside surface of the tire and the surface of the support ring. Such lubrication promotes extended durability in the friction zones that are subjected to relatively high temperatures due to the friction between the surfaces if no lubrication is provided.

### SUMMARY OF THE INVENTION

Particular embodiments of the present invention include a method of lubricating an interface between an interior surface of a tire and an outer surface of a safety support in a run-flat tire system. The method may comprise applying a gel composition at the interface, wherein the gel composition comprises a base oil and a polyvinyl alcohol, the polyvinyl alcohol having a viscosity of between 25 and 75 centipoise at 20° C. in a 4% aqueous solution.

Particular embodiments of such methods may further include applying the gel composition on the interior surface of the tire, applying the gel composition on the outer surface of the safety support or combinations thereof.

Particular embodiments of the present invention may further include a run-flat tire system, the system having a tire and a safety support mounted on a wheel rim within a tire. A gel composition may be applied to an interface between an outer surface of the safety support and an inner surface of the tire, the gel composition comprising a base oil and a polyvinyl alcohol, the polyvinyl alcohol having a viscosity of between 25 and 75 centipoise at 20° C. in a 4% aqueous solution.

The foregoing and other objects, features and advantages of the invention will be apparent from the following more detailed descriptions of particular embodiments of the invention, as illustrated in the accompanying drawings wherein like reference numbers represent like parts of the invention.

### BRIEF DESCRIPTION OF THE DRAWINGS

FIG. 1 is a graph of the rheology of a thermoreversible gel according to an embodiment of the present invention.

### DETAILED DESCRIPTION OF PARTICULAR EMBODIMENTS

Particular embodiments of the present invention include methods and systems of lubricating a run-flat tire.

Particular embodiments of methods of lubricating a run-flat tire include applying a gel composition at the interface between an interior surface of a tire and an outer surface of a safety support. The gel composition may comprise a base oil and a polyvinyl alcohol (PVA). The base oil acts generally as a lubricating agent and the PVA acts generally as a thickening agent.

Particular embodiments of the gel composition may optionally contain water in the range of between 20 and 70 wt. %, between 20 and 40 wt. % or even between 25 and 35 wt. %. Particular embodiments of the gel composition contain less than 20 wt. % water or even less than 5 wt. % water.

Particular embodiments of a gel composition according to the present invention may include a base oil such as, for example, a glycerol, a glycol or combinations thereof. In one embodiment of the gel composition, for example, glycerin (also known as glycerol and glycerine) is used as the base oil. A suitable glycerin for use in the present invention is commercially available under the trade name Star Glycerin from Proctor and Gamble (96% glycerol).

Particular embodiments of a gel composition may contain between 30 and 80 wt. % of the base oil, between 50 and 80 wt. % of the base oil or even between 60 and 80 wt. % of the base oil. In one embodiment of a gel composition, glycerin is used as the base oil at a concentration between 60 and 80 wt. %.

A gel composition according to the present invention may include a polymer as a thickener. The polymer thickens the gel sufficiently to hold the gel as distributed between an interior surface of a tire, an outer surface of a safety support or combinations thereof. A polyvinyl alcohol (PVA) may be used in several combinations of molecular weight and percent hydrolysis to obtain the desired physical characteristics.

A suitable polyvinyl alcohol may be of the form:

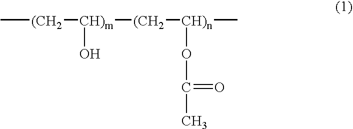

wherein the percent hydrolysis h of the polyvinyl alcohol is defined as

$$h = \frac{m}{m + n} * 100. \qquad ( 2 )$$

In particular embodiments, the PVA has a % hydrolysis h of at least 80, 84, 86 or even 92%. In alternative embodiments, the PVA may have a % hydrolysis h of at least 95, 96, 97 or 98%. A suitable PVA may include a combination of two or more compositions having differing m and n values.

In particular embodiments, the PVA may have a weight average molecular weight of between 70,000 and 140,000 or between 78,000 and 133,000.

Appropriate combinations of molecular weight and % hydrolysis in a 4% aqueous solution of the PVA will produce a solution with a viscosity of between 25 and 75 centipoise at 40° C. using a size 100 Cannon-Fenske Routine viscometer. The Cannon-Fenske Routine viscometer is available from Cannon Instrument Company in State College, PA. suitable PVA is commercially available under the trade name Polysciences PVA 15130. This PVA may be characterized as having a weight average molecular weight of 78,000 and having a percent hydrolysis h of 98%.

Particular embodiments of a gel composition may include between 2.5 and 7.5 wt. % PVA, between 2.5 and 6.0 wt. % PVA or even between 2.5 and 3.5 wt. % PVA.

Particular embodiments include a gel composition having a melt point of between 70 and 115° C. and or between about 80 and about 100° C. Melting point is measured by placing 5 milliliters of the liquid gel composition in a test tube then allowing the composition to cool in an ice water bath. The test tubes are placed upside down in an oil bath using dimethyl polysiloxanes that is heated at a rate of 1° C. per 5 minutes. The temperature at which the gel mass falls to the bottom of the test tube is recorded as the melting point.

The gel is applied to the interface between an interior surface of a tire and an outer surface of a safety support. The gel typically melts to provide lubrication during a run-flat event and remains or returns to a solid state during normal running conditions. A run-flat event is defined as a tire running at low or no pressure.

Vehicle operators demand that the tires on their cars perform at a minimum level of noise and vibration. If a gel composition moves around inside the tire during normal operation, the balance of the tire may become affected and cause the tire to become unbalanced, thereby causing excessive noise and vibration.

Particular embodiments provide a gel composition having thermoreversible properties wherein the gel may be characterized as not flowing under its own weight until the temperature reaches 70° C. or more. Upon a decrease in temperature, the gel returns to a solid form distributed about the interior surface of the tire or outer surface of the safety support.

In particular embodiments of a gel composition, the target viscosity is less than 500 centipoise. In an alternative embodiment of the present invention, the gel composition has a viscosity of between 10 and 500 or between 10 and 100 centipoise as measured at 1000 reciprocal seconds. All gel viscosities are determined as follows unless otherwise noted. Viscosity was measured at 100° C. using a Thermo Haake RheoStress1 cone-plate rheometer with a 60 mm diameter titanium cone having 1 degree of angle. The gels were melted in a water bath on a hot plate. The cone-plate was given 20 minutes to heat up to 100° C. before the gels were applied. The gels were given 20 minutes to reach temperature equilibrium on the cone-plate. During the 10 minutes of measurements the shear rate was increased logarithmically from 0.01 to 1000 reciprocal seconds while shear stress was measured and viscosity was calculated. The value at 1000 reciprocal seconds was reported as the viscosity.

In particular embodiments a gel composition may be applied to the interior surface of the tire, to the outer surface of the safety support or combinations thereof.

Particular embodiments of a method of using a gel composition include heating the gel composition and spraying the gel composition onto the interface between the interior surface of a tire and an outer surface of a safety support. The gel composition may be heated to between 70 and 110° C. or between 80 and 100° C. The spraying may be performed, for example, using a sprayer with a 1.2 millimeter nozzle at a pressure of 2.5 bar.

In particular embodiments of the present invention, a gel composition may include one or more additives such as, for example, antioxidants, coloring compounds, bactericides, surfactants or mixtures thereof. The total content of such additives in the gel composition is preferably, but not limited to, less than about 2 weight %.

In particular embodiments the gel composition should be compatible with all of the components of the run-flat tire system in which the gel composition is to be used. Such components of the run-flat system may include, for example, the tire, the safety support, the wheel, the electronic pressure monitor and any chemicals or lubricants applied separately to these or other components.

For example, the gel composition should be compatible with any of the materials that may be used for the inside of the tire and/or for the safety support. Preferred materials for the safety support include, for example, natural and synthetic rubbers as well as polymers such as polyurethane or thermoplastic elastomers (TPE). These materials, as well as the other components of the run-flat tire system, should be subjected to an aging test with the gel composition to determine their compatibility by using methods known to those having ordinary skill in the art. A gel-free control sample of each material should also be subjected to an identical aging test for comparison. Material measurements—notably weight, dimensions, Shore hardness and tensile strength—should be made before and after the aging test. Changes to the critical characteristics of the materials caused by gel incompatibility may alter the performance and/or acceptability of the system. Such changes may include, for example, swelling, shrinking, hardening, softening, becoming more or less brittle and/or changing color.

The invention is further illustrated by the following examples, which are to be regarded only as illustrations and not delimitative of the invention in any way.

### EXAMPLE 1

This example provides a procedure for mixing the components of the gel composition.

Water and a PVA (Polysciences Catalog # 15130 or 15129) with 98 and 99.7% hydrolysis respectively, were added to a mixer in the amounts shown in Table 1 and mixed for 45 minutes at 125° C. and 200 RPM to dissolve the PVA. Proctor & Gamble Star Glycerin (96% glycerol) was added in the amounts shown in Table 1 and allowed to mix for 45 minutes at 200 rpm. The composition was cooled to room temperature over several hours.

### EXAMPLE 2

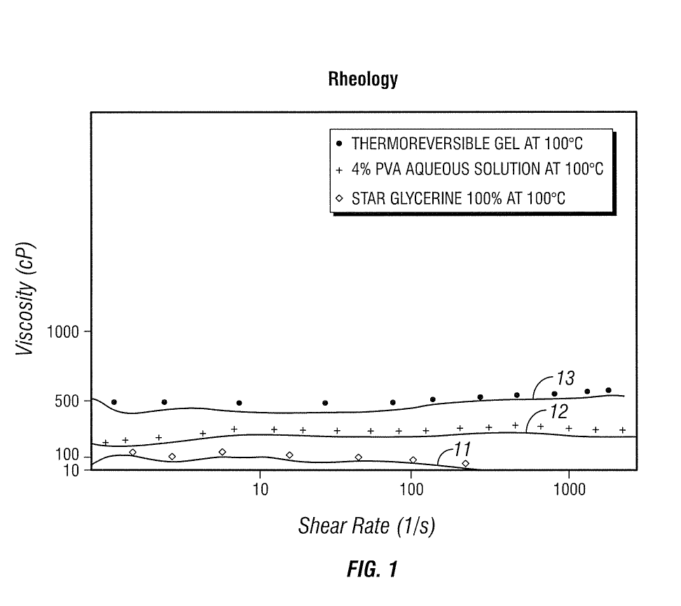

This example provides, as shown in FIG. 1, the viscosity curves of control samples and a gel composition in accordance with an embodiment of the present invention. The viscosity and shear stress of the gels were measured using a Thermo Haake RheoStress1 cone-plate rheometer with a 60 mm diameter cone having an angle of 1°. The gels were melted in a water bath on a hot plate. The cone-plate was given 20 minutes to heat up to 100° C. before the gels were applied. The gels were given 20 minutes to reach temperature equilibrium on the cone-plate. During the 10 minutes of measurements the shear rate was increased logarithmically from 0.01 to 1000 reciprocal seconds while shear stress was measured and viscosity was calculated. The value at 1000 reciprocal was reported as the viscosity. Curves 11 and 12 show the viscosity of glycerin and a 4% aqueous solution of polyvinyl alcohol, respectively. One particular embodiment of the invention is represented in viscosity curve 13 as 30% water, 70% glycerin and 3% polyvinyl alcohol.

### EXAMPLE 3

This example provides test results of gel compositions evaluated for melting point, viscosity and tire testing. In this tire testing, the tire (235-700R460 PAX) and insert (90-460(55) polyurethane) were mounted on a test wheel and the pre-measured gel was poured between the front bead and the wheel flange during mounting. The pre-measured gel amounts were 80 cm^{3,} 100 cm³, and 120 cm³. The tire was then run deflated under a 429 kilogram load at 96 kilometers per hour until either the temperature exceeded 140° C., the radius changed more than 1.5 mm, or the target distance of 300 kilometers was reached. An assembly passed the test if there was no damage to the tire or support upon reaching 300 kilometers.

TABLE 1
Results of Optimized Formulations

| | A | B | C | D | E | F |
|---|---|---|---|---|---|---|
| Water, (wt. %) | 40 | 30 | 20 | 30 | 30 | 30 |
| Glycerin, (wt. %) | 60 | 70 | 80 | 70 | 70 | 70 |
| PVA, (wt. %) 98% | 5 | 5 | 5 | 2.5 | 3 | |
| hydrolysis | | | | | | |
| PVA, (wt. %) 99.7% | | | | | | 2.5 |
| hydrolysis | | | | | | |
| Melting Point, (° C.) | 84 | 91 | 103 | 86 | 87 | 97 |
| Viscosity, (cP) | 470 | 330 | 180 | 50 | 80 | 50 |
| Tire Test | | | | | | |
| 80 cm³, (km) | | | | 154 | 100 | |
| 100 cm³, (km) | | | | 267 | 150 | |
| 120 cm³, (km) | | | | >300 | >300 | >300 |

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A method of lubricating an interface between an interior surface of a tire and an outer surface of a safety support in a run-flat tire system, the method comprising:
applying a gel composition at the interface, wherein the gel composition comprises a base oil and a polyvinyl alcohol, the polyvinyl alcohol having a viscosity of between 25 and 75 centipoise at 20° C. in a 4% aqueous solution.

2. The method of claim 1, wherein the gel composition further comprises water.

3. The method of claim 1, wherein the base oil is selected from glycerol, polyethylene glycol, polypropylene glycol or combinations thereof.

4. The method of claim 1, wherein the polyvinyl alcohol has a % hydrolysis of at least 80%.

5. The method of claim 1, wherein the gel composition has a melting point of between 70° C. and 110° C.

6. The method of claim 4, wherein the gel composition has a melting point of between 80° C. and 100° C.

7. The method of claim 1, wherein the gel composition has a viscosity of between 10 and 500 centipoise.

8. The method of claim 6, wherein the gel composition has a viscosity of between 10 and 100 centipoise.

9. The method of claim 1, further comprising:
applying the gel composition on the interior surface of the tire.

10. The method of claim 1, further comprising:
applying the gel composition on the outer surface of the safety support.

11. The method of claim 1, further comprising:
heating the gel composition; and
spraying the gel composition on the interior surface of the tire or the outer surface of the safety support.

12. The method of claim 1, wherein the gel composition further comprises:
an antioxidant, an ultra-violet dye, a surfactant and a biocide.

13. A gel composition for lubricating an interface between an inner surface of a tire and an outer surface of the safety support in a run-flat tire system, the gel composition comprising:
a base oil selected from glycerol, polyethylene glycol, polypropylene glycol or combinations thereof; and
a polyvinyl alcohol, the polyvinyl alcohol having a viscosity of between 25 and 75 centipoise at 20° C. in a 4% aqueous solution.

14. A run-flat tire system, comprising:
a tire and a safety support mounted on a wheel rim within a tire;
a gel composition applied to an interface between an outer surface of the safety support and an inner surface of the tire, the gel composition comprising:
a base oil and a polyvinyl alcohol, the polyvinyl alcohol having a viscosity of between 25 and 75 centipoise at 20° C. in a 4% aqueous solution.

15. The system of claim 13, wherein the gel composition contains water.

16. The system of claim 13, wherein the base oil is selected from glycerol, polyethylene glycol, polypropylene glycol or combinations thereof.

17. The system of claim 13, wherein the gel composition has a melting point of between 70° C. and 110° C.

18. The system of claim 17, wherein the gel composition has a melting point of between 80° C. and 100° C.

19. The system of claim 13, wherein the gel composition has a viscosity of between 10 and 500 centipoise.

20. The system of claim 19, wherein the gel composition has a viscosity of between 10 and 100 centipoise.

21. The system of claim 13, wherein the gel composition further comprises:
an antioxidant, an ultra-violet dye, a surfactant and a biocide.
